(19) United States
(12) Patent Application Publication
(10) Pub. No.: US 2014/0081622 A1
(43) Pub. Date: Mar. 20, 2014

(54) INFORMATION DISPLAY CONTROL APPARATUS, INFORMATION DISPLAY CONTROL METHOD, INFORMATION DISPLAY CONTROL SYSTEM, AND RECORDING MEDIUM ON WHICH INFORMATION DISPLAY CONTROL PROGRAM IS RECORDED

(71) Applicant: CASIO COMPUTER CO., LTD., Tokyo (JP)

(72) Inventor: Muneyuki OGAWA, Iruma-shi (JP)

(73) Assignee: CASIO COMPUTER CO., LTD., Tokyo (JP)

(21) Appl. No.: 14/031,899

(22) Filed: Sep. 19, 2013

(30) Foreign Application Priority Data
Sep. 20, 2012 (JP) 2012-206677

(51) Int. Cl. G06F 17/28

(52) U.S. Cl. CPC G06F 17/28
USPC 704/8

(57) ABSTRACT

An information display control apparatus includes a display section, a four-tone combination list display control section which displays four-tone combinations of kanji characters representing a word on the display section as a four-tone combination list, a four-tone combination selecting section which selects a four-tone combination from the four-tone combination list displayed by the four-tone combination list display control section in accordance with a user operation, and a word list display control section which displays on the display section a list of words corresponding to the four-tone combination selected by the four-tone combination selecting section.

### CROSS-REFERENCE TO RELATED APPLICATIONS

This application is based upon and claims the benefit of priority from prior Japanese Patent Application No. 2012-206677, filed Sep. 20, 2012, the entire contents of which are incorporated herein by reference.

### BACKGROUND OF THE INVENTION

1. Field of the Invention

The present invention relates to an information display control apparatus, an information display control method and the like.

2. Description of the Related Art

In a conventional electronic dictionary apparatus, as an operation of searching for a Chinese word, there are a kanji search operation of inputting kanji by handwriting, the number of strokes of a radical of the kanji, the total number of strokes of the kanji or the like and searching for a word including the input kanji and a pinyin search operation of inputting pinyin, which is a reading of a Chinese word, and searching for a word corresponding to the pinyin.

Pinyin is composed of letters representing a vowel and a consonant and a tone (first to fourth tones) representing intonation. In a usual pinyin search operation, letters of pinyin are input to search for a Chinese word corresponding to the letters of pinyin. However, there are a lot of words which correspond to the letters of pinyin but differ in tone (first to fourth tones).

In the above pinyin search operation, therefore, if a user adds a tone (first to fourth tones) to letters of pinyin of a word that the user wishes to look up, he or she can search for the word more quickly.

In addition to the above apparatus, a Chinese input conversion processing apparatus has been considered (Jpn. Pat. Appln. KOKAI Publication No. 11-96141). In this apparatus, when pinyin with a tone variation which is unique to Chinese pronunciation is input, the input pinyin is corrected to a standard notation to search a dictionary and when pinyin with a tone tremble which is also unique to Chinese pronunciation is input, its tone information is corrected to standard tone information to search a dictionary, with the result that pinyin can efficiently be converted into a Chinese word without ambiguity or uncertainty.

However, the Chinese language has a number of different pronunciations, such as dialects that vary from region to region. Therefore, the above conventional apparatuses have a problem that for example, a beginner learning Chinese is often able to listen to none of the pinyin sounds or only some of them and it is quite difficult for the beginner to search for a correct word (which the beginner wishes to look up) even if the beginner performs a fuzzy search for the word by a combination of letters and four tones of pinyin.

### BRIEF SUMMARY OF THE INVENTION

The present invention has been made to resolve the above problem and its object is to provide an information display control apparatus capable of easily searching for a Chinese word composed of a plurality of kanji characters even though it is difficult to perform a pinyin input search as well as a kanji input search.

An information display control apparatus according to the present invention comprises a display section, a four-tone combination list display control section which displays four-tone combinations of kanji characters representing a word on the display section as a four-tone combination list, a four-tone combination selecting section which selects a four-tone combination from the four-tone combination list displayed by the four-tone combination list display control section in accordance with a user operation, and a word list display control section which displays on the display section a list of words corresponding to the four-tone combination selected by the four-tone combination selecting section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an outward appearance of an electronic dictionary apparatus 10 according to an embodiment of an information display control apparatus of the present invention;

FIG. 2 is a block diagram showing an arrangement of an electronic circuit of the electronic dictionary apparatus 10;

FIG. 3 is a table showing contents of an easy-to-mistake Chinese pronunciation table 22c secured in a memory 22 of the electronic dictionary apparatus 10;

FIG. 4 is a table showing contents of a Chinese four-tone combination table 22d secured in a memory 22 of the electronic dictionary apparatus 10;

FIG. 5 is a front view showing an outward appearance of a touch panel type PDA 10T having a dictionary function according to another embodiment of the information display control apparatus of the present invention;

FIG. 6 is a flowchart showing an information display control process to be performed when “Chinese dictionary” is selected in the electronic dictionary apparatus 10;

FIG. 7 is a flowchart showing a four-tone combination list display control process associated with the information display control process to be performed when “Chinese dictionary” is selected in the electronic dictionary apparatus 10;

FIG. 8A shows a display operation (part 1) of a touch panel type color display module (main screen) 17 and that of a handwriting input module (auxiliary screen) 16, which are associated with the information display control process to be performed when “Chinese dictionary” is selected in the electronic dictionary apparatus 10;

FIG. 8B shows another display operation (part 1) of the touch panel type color display module (main screen) 17 and that of the handwriting input unit (auxiliary screen) 16, which are associated with the information display control process to be performed when “Chinese dictionary” is selected in the electronic dictionary apparatus 10;

FIG. 8C shows still another display operation (part 1) of the touch panel type color display module (main screen) 17 and that of the handwriting input module (auxiliary screen) 16, which are associated with the information display control process to be performed when “Chinese dictionary” is selected in the electronic dictionary apparatus 10;

FIG. 9A shows a display operation (part 2) of the touch panel type color display module (main screen) 17 and that of the handwriting input module (auxiliary screen) 16, which are associated with the information display control process to be performed when “Chinese dictionary” is selected in the electronic dictionary apparatus 10;

FIG. 9B shows another display operation (part 2) of the touch panel type color display module (main screen) 17 and that of the handwriting input module (auxiliary screen) 16, which are associated with the information display control process to be performed when “Chinese dictionary” is selected in the electronic dictionary apparatus 10;

FIG. 9C shows still another display operation (part 2) of the touch panel type color display module (main screen) 17 and that of the handwriting input module (auxiliary screen) 16, which are associated with the information display control process to be performed when “Chinese dictionary” is selected in the electronic dictionary apparatus 10;

FIG. 10A shows a display operation (part 3) of the touch panel type color display module (main screen) 17 and that of the handwriting input module (auxiliary screen) 16, which are associated with the information display control process to be performed when “Chinese dictionary” is selected in the electronic dictionary apparatus 10;

FIG. 10B shows another display operation (part 3) of the touch panel type color display module (main screen) 17 and that of the handwriting input module (auxiliary screen) 16, which are associated with the information display control process to be performed when “Chinese dictionary” is selected in the electronic dictionary apparatus 10; and

FIG. 11 is a block diagram showing a functional configuration in which a process similar to those of the above embodiments is performed by an information display control system including a terminal device (10A) and a server device (10B) connected to the terminal device via a network.

### DETAILED DESCRIPTION OF THE INVENTION

Embodiments of the present invention will be described with reference to the accompanying drawings.

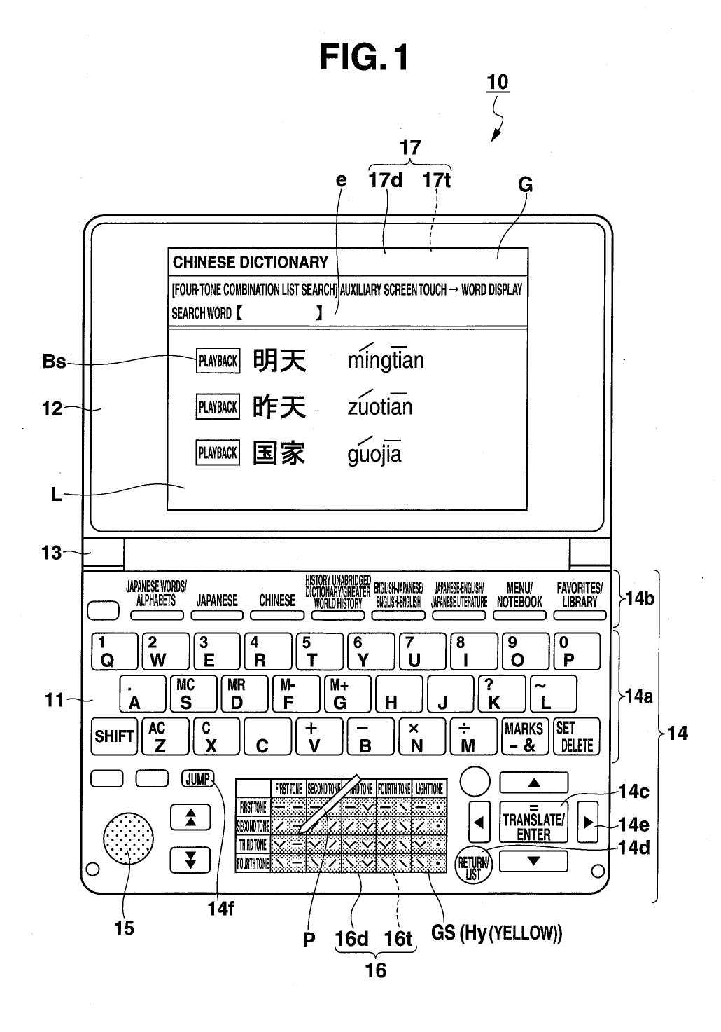

FIG. 1 is a front view showing an outward appearance of an electronic dictionary apparatus 10 according to an embodiment of an information display control apparatus of the present invention.

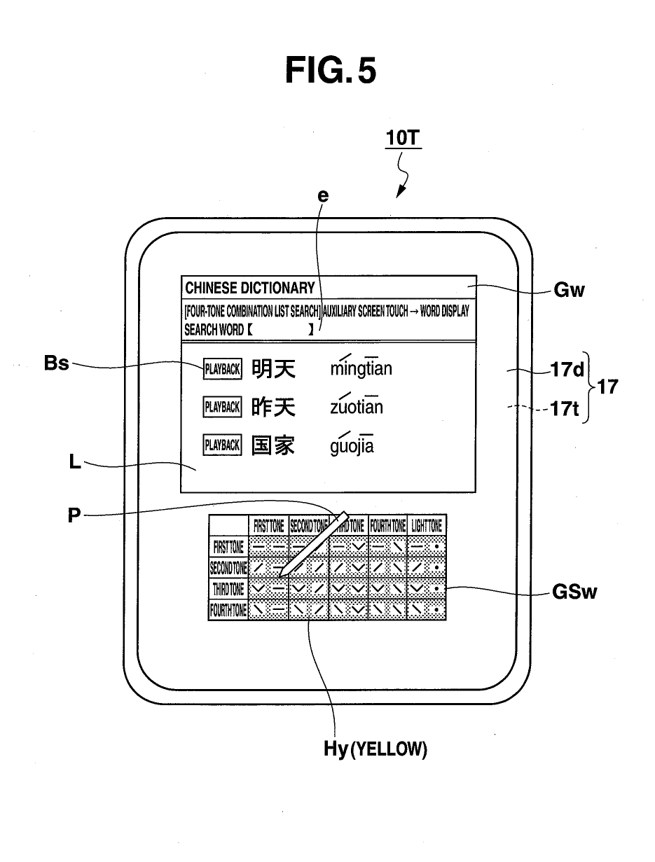

The information display control apparatus is configured as a portable device (electronic dictionary apparatus 10) dedicated to an electronic dictionary as described below or as a touch panel type personal digital assistant (PDA) 10T (see FIG. 5), a personal computer (PC), a cellular phone, an electronic book reader, a portable game console or the like, each of which has a dictionary function.

The electronic dictionary apparatus 10 is so configured that a body case 11 and a cover case 12 are coupled with each other by means of a hinge part 13 so as to form a foldable case that can be opened and closed. The body case 11 with the foldable case opened has a key input module (keyboard) 14 and a handwriting input module (auxiliary screen) 16 on its surface. The key input module (keyboard) 14 comprises character input keys 14a, dictionary selection keys 14b, a translation/enter key 14c, return/list key 14d, cursor keys 14e, a jump key 14f, a speaker 15 and the like.

The handwriting input module (auxiliary screen) 16 is provided on the front side of the central part of the key input module 14 and configured by forming a touch position detecting module for detecting a position touched by a user with a stylus, a finger or the like and a display module integrally as one unit. The handwriting input module (auxiliary screen) 16 includes a color liquid crystal display screen 16d of, e.g., 256×64 dots and a transparent touch panel 16t overlaid on the color liquid crystal display screen 16d. The input area of the handwriting input module (auxiliary screen) 16 is switched to a handwriting character (kanji) input area for inputting handwriting characters, an icon input area for inputting icons of different functions and an area mixed with these areas when the need arises.

When the handwriting input module (auxiliary screen) 16 is switched to the handwriting character input area, a trace associated with an input handwriting character is echoed back to and displayed on the liquid crystal display screen 16d of the handwriting character input area.

In a four-tone combination mode to search a Chinese dictionary for a word composed of two kanji characters from the combination of four tones of the kanji characters, a four-tone combination list screen GS is displayed on the handwriting input module (auxiliary screen) 16. This screen GS shows a list of the combinations of marks indicating four tones (first tone, second tone, third tone and fourth tone) of the first character and marks indicating four tones (first tone, second tone, third tone, fourth tone and light tone) of the last character.

The cover case 12 has a touch panel color display module (main screen) 17 with a backlight of, e.g., 480×320 dots over almost all the surface thereof. Like the handwriting input module (auxiliary screen) 16, the color display module (main screen) 17 is configured by forming a touch position detecting module for detecting a position touched by the user with a stylus, a finger or the like and a display module integrally as one unit. The color display module (main screen 17) includes a color liquid crystal display screen 17d and a transparent touch panel 17t overlaid on the color liquid crystal display screen 17d.

When the Chinese dictionary is selected as a dictionary to be searched, a Chinese dictionary search screen G is displayed on the touch panel color display module (main screen) 17.

If any four-tone combination (a combination of second tone and first tone, for example) is selected from the four-tone combination list screen GS displayed on the handwriting input module (auxiliary screen) 16, for example, words “ [symbol] ,” “ [symbol] ” and “ [symbol] ” which correspond to the selected four-tone combination are retrieved and displayed on a search word list area L.

When a “play” button Bs corresponding to each word is touched on the search word list area L, reading speech of the word is output from the speaker 15.

Therefore, even though it is difficult for a user to input a kanji or pinyin of a word that the user wishes to look up in the above four-tone combination mode, the user is able to search for the word easily from a four-tone combination corresponding to the intonation of the word to which the user has listened to.

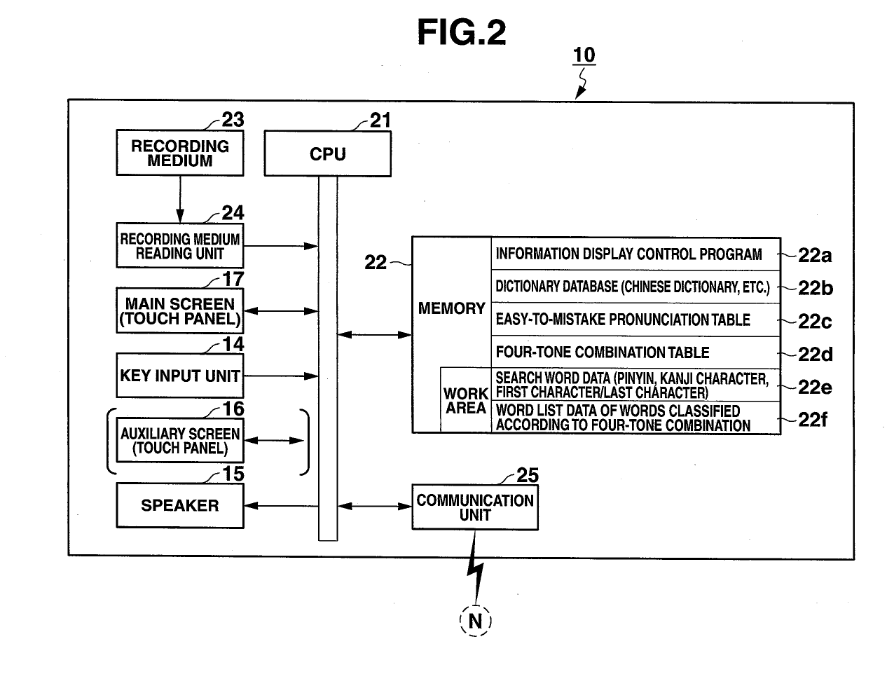

FIG. 2 is a block diagram showing an arrangement of an electronic circuit of the electronic dictionary apparatus 10.

The electronic dictionary apparatus 10 is configured by a computer which reads programs from different recording media or transferred programs and whose operation is controlled by the read programs. The electronic circuit of the dictionary apparatus 10 includes a central processing unit (CPU) 21.

The CPU 21 controls the operations of circuit elements in accordance with a device control program prestored in a memory 22, a device control program read into the memory 22 from an external storage medium 23, such as a ROM card, via a recording medium reading module 24, or a device control program read into the memory 22 from a Web server (a program server in this case) on the Internet N via a communication module 25.

The device control program stored in the memory 22 is activated in response to an input signal corresponding to a user operation from the key input module 14, handwriting input module (auxiliary screen) 16 and touch panel color display module (main screen) 17, a communication signal for communicating with each Web server on the Internet N connected via the communication module 25, or a connection communication signal for communicating with a memory card (recording medium) 23, such as an EEPROM, a RAM and a ROM externally connected via the recording medium reading module 24.

To the CPU 21, for example, the memory 22, recording medium reading module 24, communication module 25, key input module 14, speaker 15, handwriting input module (auxiliary screen) 16 and touch panel color display module (main screen) 17 are connected.

The memory 22 stores, as the device control program, a system program that supervises the operation of the entire electronic dictionary device 10 and a communication program for performing data communications with each Web server on the Internet N or a user personal computer (PC), not shown, via the communication module 25.

Furthermore, the memory 22 stores different information display control programs 22a for controlling not only the display of dictionary information but also the overall processes based on a dictionary database 22b, an easy-to-mistake Chinese pronunciation table 22c and a Chinese four-tone combination program 22d, which are stored in the memory 22, including an entry word search process for retrieving an entry word according to the input of a search word (character string), a reading and displaying process for reading and displaying explanatory information (including translation and meaning) corresponding to the retrieved entry word, a jump search process for specifying an arbitrary character string in the displayed explanatory information and making a jump to another dictionary to retrieve the specified character string, a four-tone combination word search process for searching the four-tone combinations for a target word in the four-tone combination mode to select a Chinese dictionary, and the like.

Dictionary data, such as “Chinese dictionary” in which Chinese words composed of a plurality of kanji characters, pinyin including the tones (first to fourth tones) of the words, and reading speech data and explanatory information of the words which correspond to the pinyin are compiled, is prestored or downloaded in the dictionary database 22b. The Chinese words composed of a plurality of kanji characters and the pinyin including the four tones of the kanji characters, which are stored in the “Chinese dictionary,” correspond to each other. More specifically, for example, a Chinese word “ [symbol] ” composed of a plurality of kanji characters “ [symbol] ” and “ [symbol] ” is stored and pinyin “ming2tian1” including “second tone” and “first tone” of the kanji characters is also stored to correspond to the Chinese word “ [symbol] ”. Instead of the pinyin “ming2tian1,” “mingtian21” and data corresponding to pinyin notation as in a textbook can be stored.

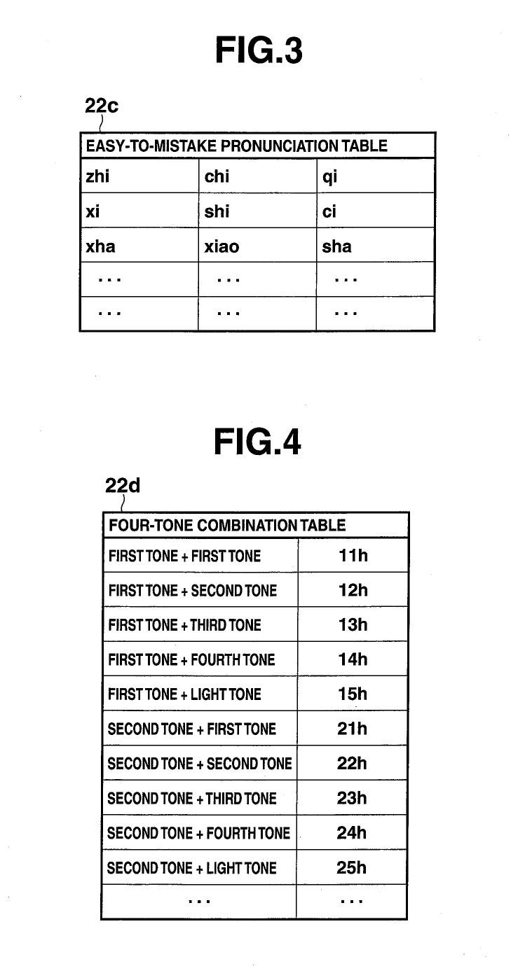

FIG. 3 is a table showing contents of an easy-to-mistake Chinese pronunciation table 22c secured in the memory 22 of the electronic dictionary apparatus 10.

Of the single-kanji characters compiled in the Chinese dictionary, easy-to-mistake kanji characters whose pronunciations are similar to one another are stored in the easy-to-mistake Chinese pronunciation table 22c along with their corresponding pinyin.

FIG. 4 is a table showing contents of a Chinese four-tone combination table 22d secured in the memory 22 of the electronic dictionary apparatus 10.

The Chinese four-tone combination table 22d stores a combination of one of the four tones (first to fourth tones) of the first character of two kanji characters that compose a Chinese word and one of the four tones (first to fourth tones and light tone (fifth tone) of the last character of the kanji characters to correspond to flags, such as flags 11h and 12h. A word of two kanji characters compiled in the “Chinese dictionary” of the dictionary database 22b corresponds to a flag corresponding to one of the four-tone combinations stored in the Chinese four-tone combination table 22d. Therefore, a word corresponding to a certain four-tone combination can be retrieved quickly on the basis of its corresponding flag.

The memory 22 includes a work area in which a search word data memory 22e and a word list data memory 22f in which words are classified according to the four-tone combination.

The search word data memory 22e stores a search word (character string) input to a search word input area e of the dictionary search screen G of a dictionary selected by a user. If the search word is Chinese, it is input as pinyin (a letter or a combination of a letter and one of the four tones (one of numerals 1 to 4)) or kanji. The memory 22e also stores Chinese search mode data indicating whether to search for a word including the search word as the first character (first-character match search) or a word including the search word as the last character (last-character match search). This Chinese search mode data is designated according to a user operation in the search word input area e and is set to the first-character match search as a default.

Assume in the following descriptions that the input of pinyin includes one of (1) letter(s) and (2) a combination of letter(s) and one of the four tones (one of numerals 1 to 4). If only the vowel and consonant of pinyin (the letter(s) representing the pinyin) are input excluding the four tones, this input will be specified as input of letters of pinyin hereinafter.

The word list data memory 22f stores the search words stored in the search word data memory 22e and the words retrieved in the search mode (first-character match search/last-character match search), these search words and retrieved words being classified according to the four-tone combination. If the search words are not input, the word list data memory 22f stores Chinese 4-level basic words each composed of two kanji characters, which are complied in the “Chinese dictionary,” these basic words being classified according to the four-tone combination.

The CPU 21 controls the operations of the circuit elements in accordance with the instructions described in the information display control programs 22a (including the programs for performing the entry word search process, explanatory information display process, jump search process, four-tone combination word search process, etc.) and operates with cooperation between software and hardware. Thus, the electronic dictionary apparatus 10 so configured carries out the function described below.

The embodiment of the information display control apparatus is achieved by the electronic dictionary apparatus 10. As a matter of course, it can be achieved by displaying input and display operations corresponding to the processing of the information display control programs 22a on the touch panel color display module 17 (17d, 17t) as different windows even in a touch panel type PDA 10T having a dictionary function, as shown in FIG. 5, for example.

FIG. 5 is a front view showing an outward appearance of the touch panel type PDA 10T having a dictionary function according to another embodiment of the information display control apparatus of the present invention.

The touch panel type PDA 10T shown in FIG. 5 performs a display operation corresponding to the four-tone combination word search process.

The Chinese dictionary search screen G displayed on the touch panel color display module (main screen) 17 of the electronic dictionary apparatus 10 shown in FIG. 1 and the four-tone combination list screen GS displayed on the handwriting input module (auxiliary screen) 16 thereof are displayed as a Chinese dictionary search window Gw and a four-tone combination list window GSw, respectively.

Next, the information display control function to be carried out when the “Chinese dictionary” is selected in the electronic dictionary apparatus 10 with the above configuration will be described.

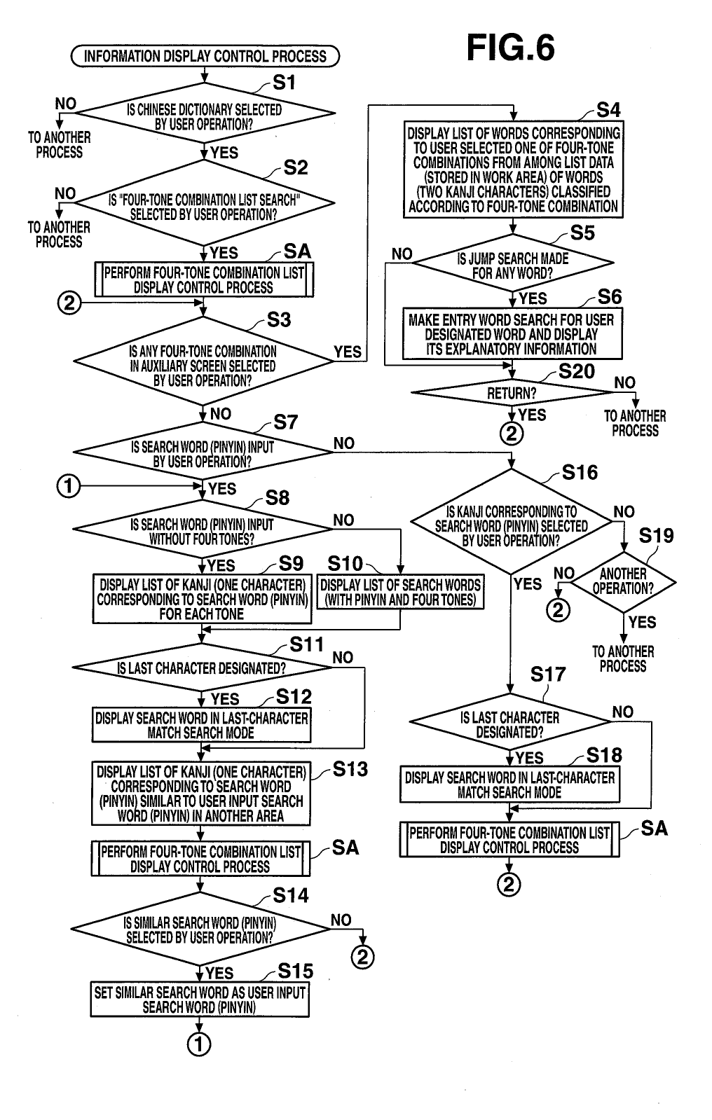

FIG. 6 is a flowchart showing an information display control process to be performed when the “Chinese dictionary” is selected in the electronic dictionary apparatus 10.

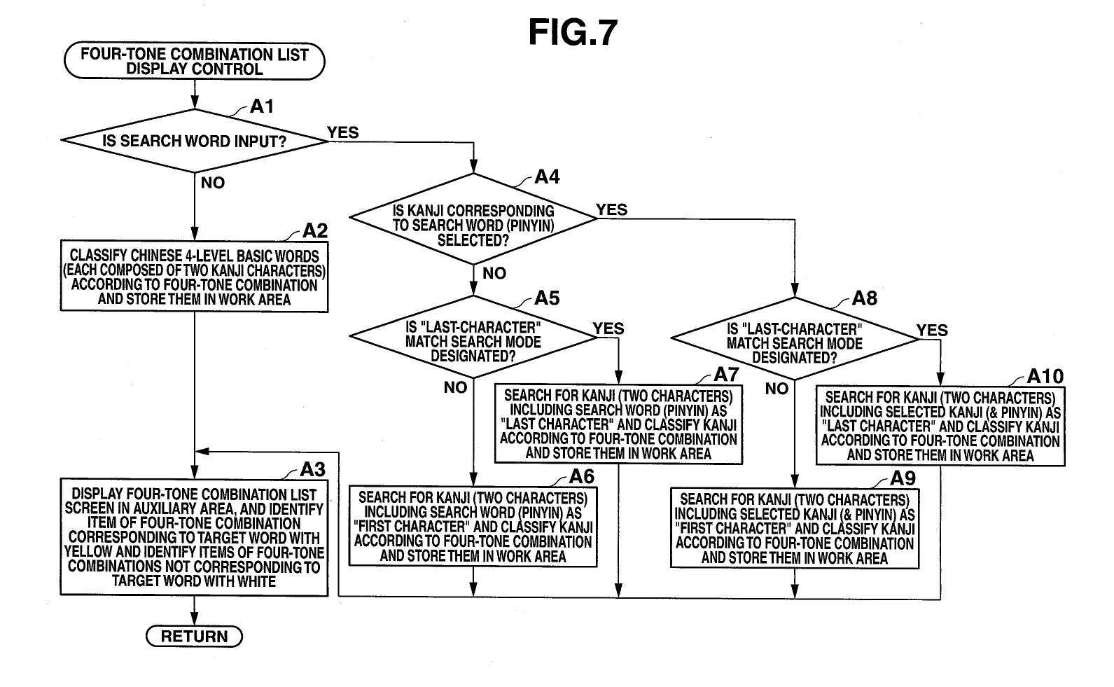

FIG. 7 is a flowchart showing a four-tone combination list display control process associated with the information display control process to be performed when the “Chinese dictionary” is selected in the electronic dictionary apparatus 10.

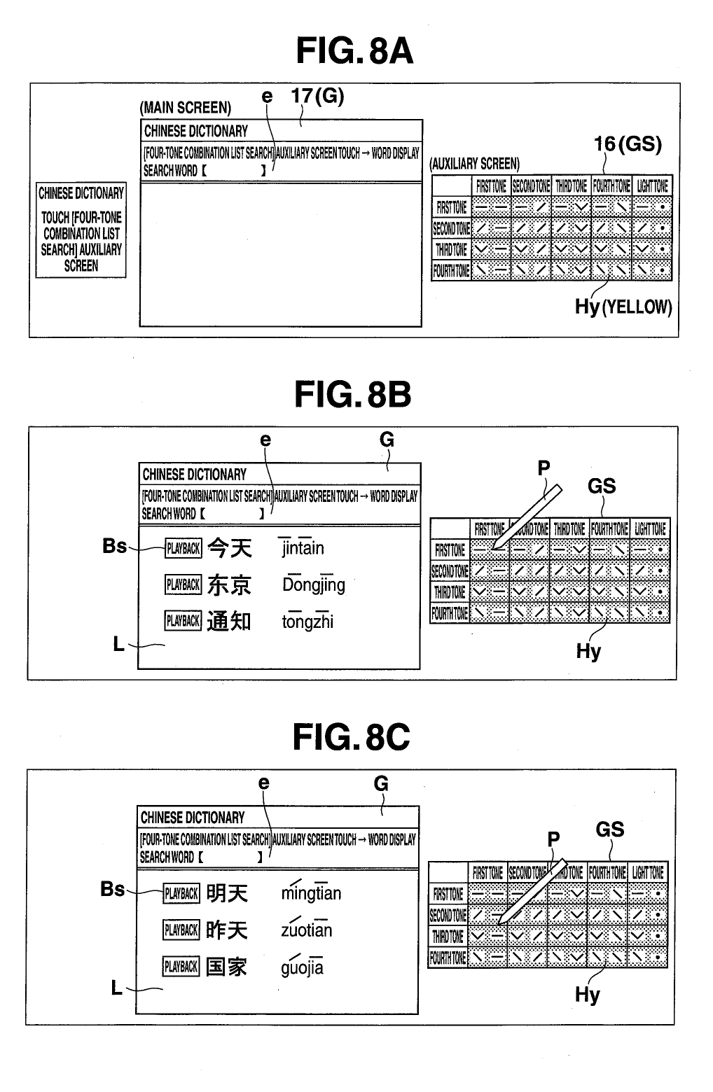

FIGS. 8A, 8B and 8C each show a display operation (part 1) of the touch panel color display module (main screen) 17 and that of the handwriting input module (auxiliary screen) 16, which are associated with the information display control process to be performed when the “Chinese dictionary” is selected in the electronic dictionary apparatus 10.

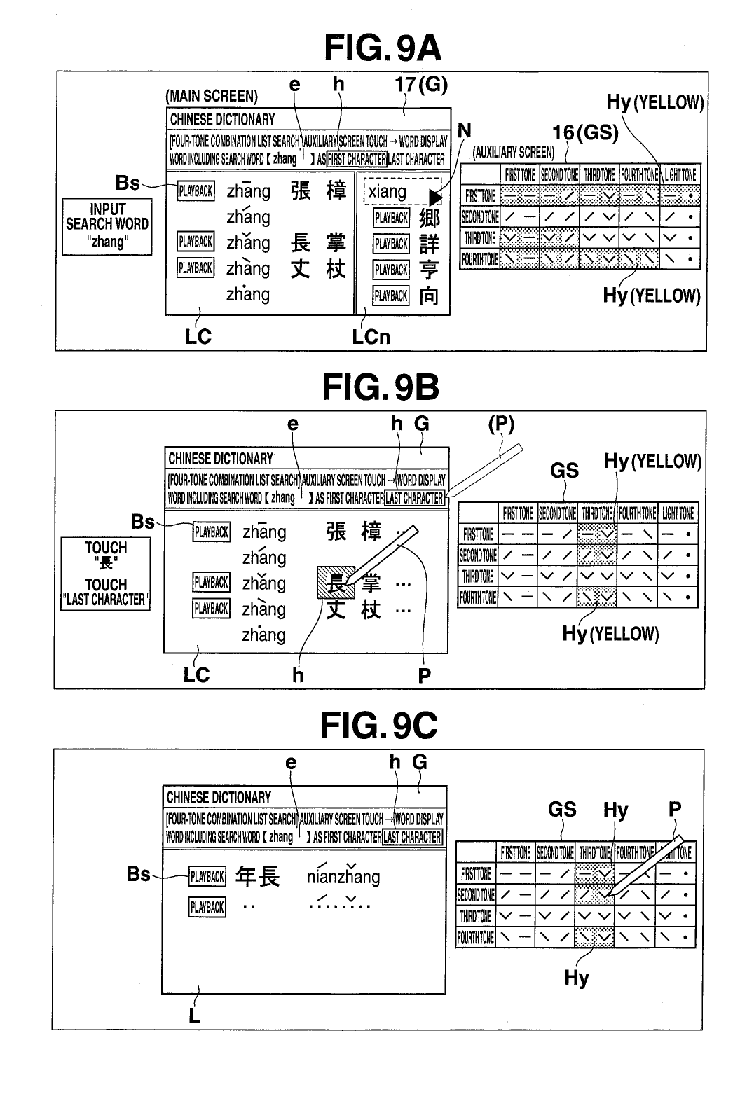

FIGS. 9A, 9B and 9C each show a display operation (part 2) of the touch panel color display module (main screen) 17 and that of the handwriting input module (auxiliary screen) 16, which are associated with the information display control process to be performed when the “Chinese dictionary” is selected in the electronic dictionary apparatus 10.

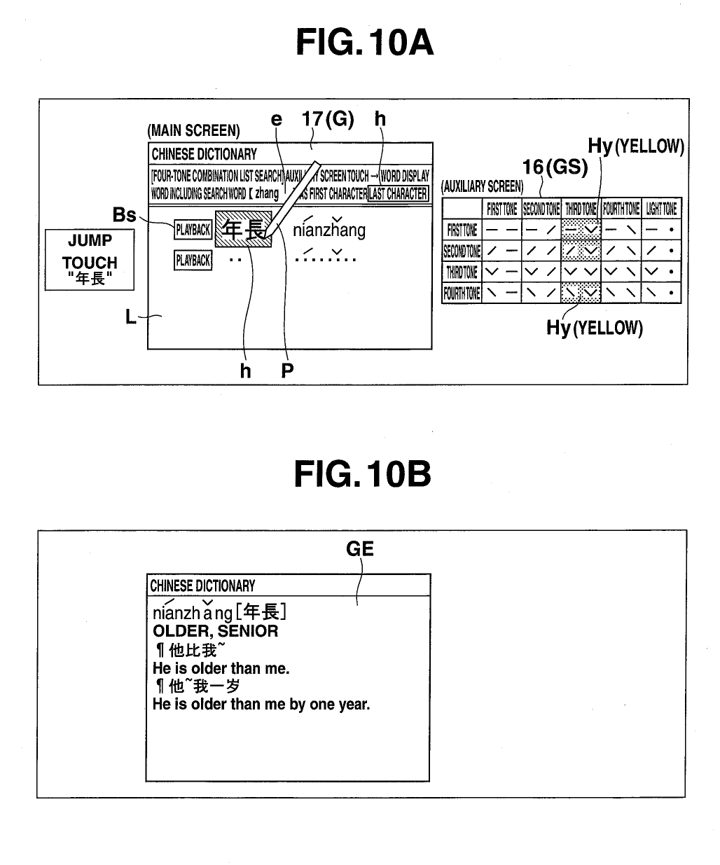

FIGS. 10A and 10B each show a display operation (part 3) of the touch panel color display module (main screen) 17 and that of the handwriting input module (auxiliary screen) 16, which are associated with the information display control process to be performed when the “Chinese dictionary” is selected in the electronic dictionary apparatus 10.

If according to a user operation of the dictionary selection keys 14b, the “Chinese dictionary” is selected (Yes in step S1) and a “four-tone combination list search” mode is designated (Yes in step S2), the touch panel color display module (referred to as “main screen” hereinafter) 17 displays the Chinese dictionary search screen G as shown in FIG. 8A, and the flow moves to the four-tone combination list display control process shown in FIG. 7 (step SA).

When the four-tone combination list display control process is started, it is determined whether a search word is input to the search word input area e of the Chinese dictionary search screen G (step A1). If it is determined that no search word is input (No in step A1), the Chinese 4-level basic words each composed of two kanji characters, which are complied in the “Chinese dictionary,” are classified according to the four-tone combination and then stored in the word list data memory 22f of the work area (step A2).

Then, the four-tone combination list screen GS based on the four-tone combination table 22d is displayed on the handwriting input module (referred to as “auxiliary screen” hereinafter) 16, and an item of a four-tone combination corresponding to a target word stored in the word list data memory 22f is identified with yellow (Hy) and the other items of the four-tone combinations not corresponding to the target word are identified with white (step A3).

For example, when a user wishes to look up a word to which he or she has heard, the pronunciation of which is a four-tone combination of the first tone and the first tone, he or she touches a corresponding item “first tone and first tone” on the four-tone combination list screen GS with a stylus (P) and selects it (Yes in step S3). Of the basic words classified according to the four-tone combination and stored in the word list data memory 22f, the words of the selected four-tone combination (first tone and first tone), such as “ [symbol] ,” “ [symbol] ” and “ [symbol] ” are read out and listed in the search word list area L of the main screen 17 (Chinese dictionary search screen G) (step S4).

Note that the kanji characters described in this specification are not those used in Chine but those used in Japan.

Likewise, as shown in FIG. 8C, a user touches an item “second tone and first tone” on the four-tone combination list screen GS displayed on the auxiliary screen 16 with stylus P and selects it (Yes in step S3). Thus, of the basic words classified according to the four-tone combination, which are stored in the word list data memory 22f, the words “ [symbol] ,” “ [symbol] ” and “ [symbol] ” of the selected item “second tone and first tone” are read out and listed on the search word list area L of the main screen 17 (Chinese dictionary search screen G) (step S4).

If a jump search mode is set in a target one of the words of a desired four-tone combination, which are listed on the search word list area L, by the “jump” key 14f to designate a jump search (step S5), explanatory information stored in the “Chinese dictionary” as an entry word of the target word and displayed on the main screen 17 as an explanatory information display screen GE (see FIG. 10B) (step S6).

Thus, the user can search for and look up a desired word easily from a four-tone combination indicative of the intonation of the word even though the user does not know the kanji or pinyin of the word.

When the user has some knowledge of the pinyin of part of a word (first one or last one of two characters composing the word) that the user wishes to look up, if, as shown in FIG. 9A, the user inputs the letters “zhang” corresponding to the pinyin (search word) to the search word input area e of the Chinese dictionary search screen G (Yes in step S7), it is determined whether the pinyin is input without four tones (numerals 1 to 4) but with letters only (step S8).

If the pinyin is input without four tones (numerals 1 to 4) but with letters “zhang” only (Yes in step S8), the kanji characters (first tone: “ [symbol] ” and “ [symbol] ”, third tone: “ [symbol] ” and “ [symbol] ”, fourth tone: “ [symbol] ” and “ [symbol] ”) which correspond to the letters “zhang” are classified for each of the four tones and displayed on the search kanji list area LC (step S9).

If it is determined that pinyin (search word) is input to the search word input area e with four tones (combination of letter(s) and four tones of numerals 1 to 4) (No in step S8), the kanji characters corresponding to the input pinyin with four tones are listed and displayed on the search kanji list area LC (step S10).

In the search word input area e, notation “first character” for selecting the first-character match search mode is displayed as a default (h). If the user touches notation “last character” (Yes in step S11), the search mode is set in the last-character match search mode and the notation “last character” is displayed (h) (step S12).

Furthermore, a pinyin word “xiang” similar to the pinyin word “zhang” input to the search word input area e is read out of the easy-to-mistake Chinese pronunciation table 22c, and the kanji characters such as “ [symbol] ,” “ [symbol] ,” “ [symbol] ” and “ [symbol] ” which correspond to the pinyin word “xiang” are displayed in a similar pinyin kanji list area LCn (step S13).

In the above example, when the pinyin word “zhang” is input, the kanji characters such as “ [symbol] ,” “ [symbol] ,” “ [symbol] ” and “ [symbol] ” which correspond to the pinyin letters “xiang” similar to the pinyin letters “zhang” are displayed in the similar pinyin kanji list area LCn. If, however, pinyin (search word) is input with four tones (combination of letter(s) and four tones of numerals 1 to 4), kanji characters corresponding to pinyin with four tones which are similar to the pinyin with four tones are displayed in the similar pinyin kanji list area LCn. If, for example, pinyin “zhang1” with four tones is input, kanji characters such as “ [symbol] ” corresponding to pinyin “xiang1” with four tones which are similar to the pinyin “zhang1” with four tones are displayed in the similar pinyin kanji list area LCn.

If the user touches a next candidate mark N in the similar pinyin kanji list area LCn, kanji characters corresponding to the next similar pinyin word “chang” are displayed in place of the former kanji characters.

The flow moves to the four-tone combination list display control process shown in FIG. 7 (step SA). If it is determined that no kanji character is selected from the kanji characters corresponding to the search word (pinyin) “zhang” and displayed in the search kanji list area LC and the similar pinyin kanji list area LCn (No in step A4), it is determined whether the last-character match search mode “last character” is designated or not (step A5).

Then, if it is determined that the last-character match search mode “last character” is not designated, or the first-character match search mode “first character” is designated (No in step A5), the words including as their first characters the kanji characters (first tone: “ [symbol] ” and “ [symbol] ”, third tone: “ [symbol] ” and “ [symbol] ”, fourth tone: “ [symbol] ” and “ [symbol] ”) which correspond to the search word (pinyin) “zhang” are retrieved and then classified according to the four-tone combination and stored in the word list data memory 22f of the work area (step A6).

Then, the four-tone combination list screen GS based on the four-tone combination table 22d is displayed on the auxiliary screen 16, and the four-tone combination items “first tone and first tone” to “first tone and light tone,” “third tone and first tone,” “third tone and second tone” and “fourth tone and first tone” to “fourth tone and fourth tone,” which include the words classified according to the four-tone combination and stored in the word list data memory 22f, are identified and displayed with yellow (Hy) (step A3).

If the user touches and selects any one of the four-tone combination items identified and displayed on the four-tone combination list screen GS with stylus P (Yes in step S3), of the words including as their first characters the kanji characters corresponding to the search word (pinyin) “zhang” stored in the word list data memory 22f, the words corresponding to the selected one of the four-tone combination items are read out, and listed and displayed in the search word list area L (see FIGS. 8B and 8C) of the Chinese dictionary search screen G (step S4).

If it is determined in step A5 that the last-character match search mode “last character” is designated (Yes in step A5), the words including as their last characters the kanji characters (first tone: “ [symbol] ” and “ [symbol] ”, third tone: “ [symbol] ” and “ [symbol] ”, fourth tone: “ [symbol] ” and “ [symbol] ”) which correspond to the search word (pinyin) “zhang” are retrieved, and classified according to the four-tone combination and stored in the word list data memory 22f of the work area (step A7).

When the user selects similar pinyin (search word) “xiang” displayed in the similar pinyin kanji list area LCn (Yes in step S14), the selected similar pinyin (search word) “xiang” is set and stored in the search word data memory 22e as the search word (pinyin) input by the user (step S15). After that, the flow returns to step S8.

If, as shown in FIG. 9, a kanji character “ [symbol] ” is touched with stylus P and selected from among the kanji characters (first tone: “ [symbol] ” and “ [symbol] ”, third tone: “ [symbol] ” and “ [symbol] ”, fourth tone: “ [symbol] ” and “ [symbol] ”) which correspond to the input search word (pinyin) “zhang” and which are displayed in the search kanji list area LC and then displayed (h) because the user determines that the kanji character “ [symbol] ” is included as the last one in a word that the user wishes to look up (Yes in step S16) and the notation “last character” in the search word input area e is touched with stylus P (Yes in step S17), the last-character match search mode is selected and the notation “last character” is designated and displayed (h) (step S18).

The flow moves to the four-tone combination list display control process shown in FIG. 7 (step SA). Thus, it is determined that the kanji character “ [symbol] ” which corresponds to the search word (pinyin) “zhang” displayed in the search kanji list area LC is selected (Yes in step A4) and it is also determined that the last-character match search mode “last character” is selected (Yes in step A8).

Then, the words each including the selected kanji character “ [symbol] ” as the last character are retrieved, and these words are classified according to the four-tone combination and stored in the word list data memory 22f of the work area (step A10).

Then, the four-tone combination list screen GS based on the four-tone combination table 22d is displayed on the auxiliary screen 16, and the four-tone combination items “first tone and third tone,” “second tone and third tone” and “fourth tone and third tone,” which include the words classified according to the four-tone combination and stored in the word list data memory 22f, are identified and displayed with yellow (Hy) (step A3).

If, as shown in FIG. 9C, the four-tone combination item “second tone and third tone” identified and displayed (Hy) in the four-tone combination list screen GS is touched with stylus P and selected (Yes in step S3), a word “ [symbol] ” included in the selected four-tone combination item “second tone and third tone” is read out of the words each including the kanji character “ [symbol] ”, which corresponds to the search word (pinyin) stored in the word list data memory 22f, as the last character and displayed in the search word list area L of the Chinese dictionary search screen G (step S4).

If, as shown in FIG. 10A, the jump search mode is selected, and the word “ [symbol] ”, which is included in the words of a desired four-tone combination “second tone and third tone” including the kanji character “ [symbol] ” of the search word (pinyin) displayed in the search word list area L and which the user wishes to look up, is touched with stylus P and displayed (h) (step S5), explanatory information corresponding to word “ [symbol] ” as an entry word is read out of the “Chinese dictionary” and, as shown in FIG. 10B, the explanatory information display screen GE is designated and the explanatory information is displayed therein (step S6).

If it is determined that the last-character match search mode “last character” is not designated (No in step A8), the words each including the selected kanji character “ [symbol] ” as the first character are retrieved and then classified according to the four-tone combination and stored in the word list data memory 22f of the work area 22f (step A9).

Accordingly, even though the user knows only part of the pinyin of a desired word that the user wishes to look up, the user can refine the search for the word easily from a four-tone combination indicative of the pinyin and intonation of the word.

Therefore, according to the information display control function performed when the “Chinese dictionary” is selected in the electronic dictionary apparatus 10 with the above configuration, if the four-tone combination mode in which a word composed of two kanji characters is retrieved from the combinations of four tones of the kanji characters is selected, the four-tone combination list screen GS in which the combinations of marks representing the four tones (first tone, second tone, third tone and fourth tone) of the front character and marks representing the four tones (first tone, second tone, third tone, fourth tone and light tone) of the last character are listed, is displayed on the auxiliary screen 15. If a four-tone combination corresponding to the intonation of a word which the user listens to and wishes to look up is selected on the four-tone combination list screen GS, the words corresponding to the selected four-tone combination are retrieved and displayed on the search word list area L.

For this reason, even though the user does not know the kanji or pinyin of a desired word that the user wishes to look up, the user can search for and look up the word easily from a four-tone combination indicative of the intonation of the word.

Furthermore, according to the information display control function performed when the “Chinese dictionary” is selected in the electronic dictionary apparatus 10 with the above configuration, when the user knows the pinyin of part (first character/last character) of a word that the user wishes to look up and inputs the pinyin as a search word, the kanji characters corresponding to the input pinyin are retrieved and displayed on the search kanji list area LC. If a desired kanji character is selected from the list of kanji characters whose pinyin sounds are retrieved, the words including the selected kanji character are retrieved and a four-tone combination item corresponding to the four-tone combination of each of the retrieved kanji characters is identified and displayed (Hy).

For this reason, even though the user knows only part of the pinyin of a desired word that the user wishes to look up, the user can refine the search for the word easily from a four-tone combination indicative of the pinyin and intonation of the word.

Therefore, according to the information display control function performed when the “Chinese dictionary” is selected in the electronic dictionary apparatus 10 with the above configuration, the operation of searching for a word including a kanji character whose pinyin is retrieved as the first character (first-character match search) and identifying and displaying (Hy) a four-tone combination item corresponding to the four-tone combination of the word or the operation of searching for a word whose pinyin is retrieved as the last character (last-character match search) and identifying and displaying (Hy) a four-tone combination item corresponding to the four-tone combination of the word can be selected appropriately by designating and displaying (h) the notation (first character/last character) in the search word input area e in accordance with the user operation.

Furthermore, according to the information display control function performed when the “Chinese dictionary” is selected in the electronic dictionary apparatus 10 with the above configuration, when the pinyin (search word) is input and a list of the retrieved kanji characters is displayed on the search kanji list area LC, kanji characters of pinyin similar to the input pinyin are also retrieved and displayed on the similar pinyin kanji list area LCn. Thus, even though the user is uncertain about the pinyin of part of a desired word that the user wishes to look up, the user can refine the search for the word easily from a four-tone combination indicative of the pinyin and intonation of the word.

In the above embodiment, a specific example of searching for a word composed of two kanji characters has been described. However, even if a user searches for a desired word composed of three or more kanji characters, if the search is made on the basis of the combination of the four tones of the first character of the word and those of the last character thereof, the user can refine the search for the desired word as in the above embodiment.

The methods and database for the individual processes performed by the electronic dictionary apparatus 10 according to the embodiment, namely, the methods such as the information display control process shown in the flowchart of FIG. 6 and the four-tone combination list display control process associated with the information display control process shown in the flowchart of FIG. 7, and the dictionary database 22b, easy-to-mistake Chinese pronunciation table 22c and Chinese four-tone combination program 22d can be stored in and distributed to the external recording medium 23, such as a memory card (e.g., a ROM card and a RAM card), a magnetic disk (e.g., a floppy disk and a hard disk), an optical disk (e.g., a CD-ROM and a DVD), and a semiconductor memory, in the form of programs that can be executed by the computer. The computer of an electronic apparatus including the main and auxiliary display screens 17 and 16 loads the program stored in the external recording medium 23 into the memory 22. The computer is controlled by the read-in program, with the result that the word search function can be achieved by the four-tone combination described in the above embodiment and the same processes in the aforementioned methods as explained can be carried out.

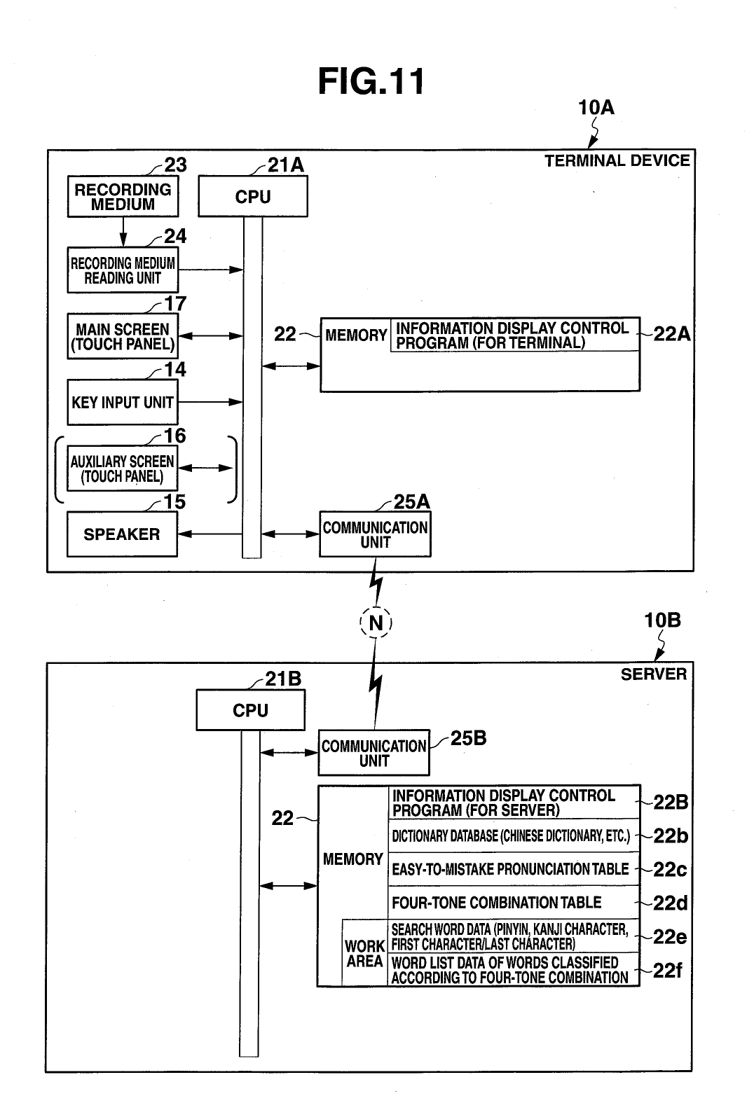

FIG. 11 is a block diagram showing a functional configuration in which a process similar to those of the above embodiments is performed by an information display control system including a terminal device 10A and a server device 10B connected to the terminal device via a network. In FIGS. 2 and 11, the same structural elements are denoted by the same reference numerals. As shown in FIG. 11, the terminal device 10A includes a CPU 21A, an input unit 14, a display unit (main screen touch panel) 17, a memory 22 and a communication unit 25A. The memory 22 stores an information display control program 22A, and the CPU 21A performs a process according to the information display control program 22A. More specifically, the CPU 21A transmits data corresponding to a user designating operation and input operation from the communication unit 25A to the server device 10B via the network N, receives processed result data from the server device 10B, and displays it on the display unit 17. The server device 10B includes a CPU 25B for transmitting and receiving information from and to the terminal device 10A via the network N and a memory 22. The memory 22 stores different data items, which include an information display control program 22B and a dictionary database 22b, tables 22c and 22d and a work area. Upon receiving data from the terminal device 10A, the CPU 21B of the server device 10B processes the different data items and data of the tables and transmits a processing result to the terminal device 10A.

In the configuration of FIG. 11, the server device 10B stores different data items including the dictionary database 22b and the tables. However, the terminal device 10A may store some of the databases and tables and perform part of a process corresponding to a user input operation.

Furthermore, the data of the programs which realize the above methods can be transferred in the form of program code through a network N. The program data can be loaded into a computer connected to the network N by the communication control unit 25, thereby realizing the information display function involving the above word search function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information display control apparatus comprising:
a display section;
a four-tone combination list display control section which displays four-tone combinations of kanji characters representing a word on the display section as a four-tone combination list;
a four-tone combination selecting section which selects a four-tone combination from the four-tone combination list displayed by the four-tone combination list display control section in accordance with a user operation; and
a word list display control section which displays on the display section a list of words corresponding to the four-tone combination selected by the four-tone combination selecting section.

2. The information display control apparatus of claim 1, further comprising a word storage section which stores a plurality of combinations of words each composed of a plurality of kanji characters and pinyin representing tones of the kanji characters in correspondence with each other,
wherein the word list display control section reads words corresponding to the four-tone combination selected by the four-tone combination selecting section from the words stored in the word storage section and displays a list of the words on the display section.

3. The information display control apparatus of claim 2, further comprising:
a pinyin input section which inputs pinyin according to a user operation; and
a pinyin kanji search section which searches for kanji characters corresponding to the pinyin input by the pinyin input section,
wherein the four-tone combination list display control section includes a word search section which searches the words stored in the word storage section for a word including the kanji characters retrieved by the pinyin kanji search section, and displays on the display section a four-tone combination of the kanji characters of the word retrieved by the word search section as a four-tone combination list.

4. The information display control apparatus of claim 3, wherein the four-tone combination list display control section includes:
an all-four-combination list display control section which displays on the display section a list of all four-tone combinations each including a tone of a first kanji character and a tone of a last kanji character which compose a word; and
a four-tone combination identification display control section which identifies and displays one of the all four-tone combinations displayed by the all-four-combination list display control section, which corresponds to the four-tone combination of the kanji characters of the word retrieved by the word search section.

5. The information display control apparatus of claim 3, further comprising:
a search kanji character list display control section which displays a list of the kanji characters retrieved by the pinyin kanji search section on the display section; and
a kanji character selecting section which selects a kanji character from the list displayed by the search kanji character list display control section in accordance with a user operation,
wherein the word search section searches for a word including the kanji character selected by the kanji character selecting section.

6. The information display control apparatus of claim 3, wherein the word search section includes a first character/last character designating section which designates one of first-character match search and last-character match search, and the word search section searches for words each including one of the kanji characters retrieved by the pinyin kanji search section as a first character from the words stored in the word storage section when the first character/last character designating section designates the first-character match search, and the word search section searches for words each including one of the kanji characters retrieved by the pinyin kanji search section as a last character from the words stored in the word storage section when the first character/last character designating section designates the last-character match search.

7. The information display control apparatus of claim 5, further comprising:
a similar pinyin kanji character search section which searches for kanji characters corresponding to pinyin similar to the pinyin input by the pinyin input section; and
a similar pinyin kanji character list display control section which displays a list of the kanji characters retrieved by the similar pinyin kanji character search section on the display section,
wherein the kanji character selecting section selects a kanji character from the kanji characters displayed by the search kanji character list display control section and the kanji characters displayed by the similar pinyin kanji character search section according to a user operation.

8. An information display control method for controlling a computer of an electronic apparatus including a display section and a memory, comprising:
displaying four-tone combinations of kanji characters representing a word on the display section as a four-tone combination list;
selecting a four tone combination from the four-tone combination list according to a user operation; and
displaying a list of words corresponding to the selected four-tone combination on the display section.

9. An information display control system including a terminal device and a server device connected to the terminal device via a network, the system comprising:
a four-tone combination list display control section which displays four-tone combinations of kanji characters representing a word as a four-tone combination list;
a four-tone combination selecting section which selects a four-tone combination from the four-tone combination list displayed by the four-tone combination list display control section in accordance with a user operation; and
a word list display control section which displays a list of words corresponding to the four-tone combination selected by the four-tone combination selecting section.

10. A non-transitory storage medium on which an information display control program for controlling a computer of an electronic apparatus including a display section and a memory, the information display control program causing the computer to serve as:
a four-tone combination list display control section which displays four-tone combinations of kanji characters representing a word on the display section as a four-tone combination list;
a four-tone combination selecting section which selects a four-tone combination from the four-tone combination list displayed by the four-tone combination list display control section in accordance with a user operation; and
a word list display control section which displays on the display section a list of words corresponding to the four-tone combination selected by the four-tone combination selecting section.
